(19) United States
(12) Patent Application Publication
(10) Pub. No.: US 2012/0089369 A1
(43) Pub. Date: Apr. 12, 2012

(54) Medical sensor data manager

(76) Inventors: Patrick Abuzeni, Key Biscayne, FL (US); Roger D. Perryman, Sunny Isles, FL (US)

(21) Appl. No.: 12/924,878

(22) Filed: Oct. 7, 2010

(51) Int. Cl. G06F 15/00

(52) U.S. Cl. 702/188

(57) ABSTRACT

The problem of collecting and delivering stand alone medical sensor and monitoring device data to a networked computer system is solved by connecting the output of the sensors and devices to a vital sign sensor connector adapted to connect into a multiple input sensor casing having a routing hub and computer logic for transmitting incoming sensor and device data to one or more networked computer systems.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Currently, a typical vital sign device/monitor today is a freestanding unit that has a variety of sensors that connect to one device with a built-in screen. These devices are self-contained and are not typically capable of being connected to a computer or communication network. There are some devices that are capable of being networked, but require the installation of a proprietary software and server hardware specific to the device. Unless a device/monitor includes a network package, the end-user has no ability to easily access captured vital sign data anywhere else other than the built-in screen.

The typical vital sign monitors/devices are of proprietary nature and therefore lack a common communication protocol. These devices can be made to communicate with devices designed and produced by same manufacturer but not any other manufacturer.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a layout of an integrated USB device system with wired connectivity consistent with certain embodiments of the present invention.

FIG. 2 is a layout of an integrated USB device system with wireless connectivity consistent with certain embodiments of the present invention.

FIG. 3 is an internal view of an integrated USB sensor casing consistent with certain embodiments of the present invention.

FIG. 4 is an external, anterior view of an integrated USB sensor casing consistent with certain embodiments of the present invention.

FIG. 5 is an internal view of a sensor connector for insertion into the sensor casing consistent with certain embodiments of the present invention.

FIG. 6 is a side view of a sensor connector for insertion into the sensor casing consistent with certain embodiments of the present invention.

FIG. 7 is an overview of an operational measurement action consistent with certain embodiments of the present invention.

FIG. 8 is an USB message format diagram consistent with certain embodiments of the present invention;

FIG. 9 is a message format diagram for device parameters to be communicated consistent with certain embodiments of the present invention;

FIG. 10 is a message format diagram for sensor parameters to be communicated consistent with certain embodiments of the present invention;

FIG. 11 is a message format diagram for message parameters to be communicated consistent with certain embodiments of the present invention;

FIG. 12 is an operational flow diagram for sensor device initialization consistent with certain embodiments of the present invention;

FIG. 13 is an operational flow diagram for sensor device data collection operation consistent with certain embodiments of the present invention;

FIG. 14 is an operational flow diagram for the listener software application operation consistent with certain embodiments of the present invention;

FIG. 15 is an operational flow diagram for server software application operation consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The multi-sensor data stream manager in an exemplary embodiment may provide an ability to interface with and collect input from a wide variety of devices, tagging the input with a label that identifies the input for a particular device and patient, and communicate the sensor input data to both a nearby personal computer and a networked communication server. The communication between the sensor devices and the computer and networked servers in the system may be facilitated either through a wired connection or a wireless communication connection. The multi-sensor data stream manager system may be composed of input devices, a client software application, and a server software application in which the software applications are instantiated within a conduit computer system and a server computer system to facilitate the configuration of measurement data from the input devices, and the collection and storage of all measurement data.

Input devices that will collect and transmit the input to the personal computer and data communication server may be a variety of input devices that share a single Universal Serial Bus (USB) connection integral to a sensor device casing. The USB interconnection may be through a powered USB hub within the sensor device casing that collects USB formatted communication messages from a plurality of inserted devices and transmits them to a personal computer through a single USB connection port. These messages will be transmitted to the personal computer as user defined packets which may contain input data from any of a number of input devices.

Input devices may be any device for capturing and transmitting audio, aural, text, measurement, calibration, video, or multimedia sensor input to the multi-sensor data stream manager such as a digital camera, a document scanner, USB configured medical sensor devices that detect EKG, SaO2, ETCO2, Temperature, Blood Pressure, EEG, or any other sensor device used to collect and transmit measurement or patient information. In an exemplary embodiment the sensor devices that collect and transmit measurement data and other information to the system may be self-contained sensor devices. The sensor devices may be connected to the personal computer or a server computer through a sensor device casing using the integral USB port, or they may be connected independently from the sensor device casing through a separate USB connection or wireless connection, or messages may be transmitted from a combination of input devices connected to the sensor device casing and independently connected devices. In this regard the input devices may be sensor devices that may be capable of detecting vital medical sign input and performing the measurement and data collection action of any single sensor device without the assistance or cooperation of an additional sensor device. This independent action may provide any sensor device with the ability to process the measurement data gathered as input and transmit the resulting processed data to a designated computer for display to a user of the system.

In this exemplary embodiment the processed data from each sensor device is transmitted to a conduit software application module operating within the personal computer. The conduit software application may be configured to recognize sensor devices that are connected to a sensor device casing through a USB connection. Each sensor device may have a USB connector that establishes contact between the sensor device and the sensor device casing when the USB connector on the device is inserted into a USB port within the sensor device casing. Alternatively, a sensor device may be independently connected to a USB port associated with the designated computer system but external to the sensor device casing.

In an additional exemplary embodiment, each sensor device may be designed with an included universal adaptor for connecting the sensor device output to an input port on a designated computer or an input port on a USB sensor device installed within a sensor device casing. The universal adaptor may be capable of adapting the output from a number of different vital sign sensor devices such as, in a non-limiting example, devices for EKG, SaO2, ETCO2 and blood pressure measurement capture, as well as other vital sensor devices. The universal adaptor may be a USB capable adaptor that accommodates output from a sensor device having a USB output.

The universal sensor device with a USB output may contain the intelligence and versatility to gather and distinguish among different types of collected vital sign data. The choice of which type of vital sign sensing data is being communicated may be confirmed after coupling the device to a designated conduit computer system, such as, in a non-limiting implementation, a personal computer (PC) system. The conduit PC is responsible for initializing a sensor device and/or a sensor device casing and initiating data streaming from connected sensor devices. The conduit PC may be used in both wired and wireless communication configurations. A custom designed conduit computer application module may identify the sensor type based upon the input data being received and provide the user with the choice to confirm the acceptance of the input data as well as the interpretation of the received data.

The universal adaptor will be an integral component in the assurance of the integrity of the data received. The physical configuration of the universal adaptor may be identical for all sensor devices with which it connects, with the activation of connector contact points determined by the configuration of the sensor device to which the universal connector is attached. The universal adaptor may contain a pre-programmed code to uniquely identify the type of sensor device to which the universal adaptor is connected based upon the configuration of sensor device, such as the number and type of electrodes in a non-limiting example, and the type and format of the vital sign sensing data being captured by the sensor device.

Once connected, the conduit software application installed within the designated computer system detects the connected sensor device and establishes communication with the connected sensor device. This data connection may occur through the use of a USB type connector or through a wireless communication connection. Communication with each of the sensor devices may use USB-style protocols, with messages from the sensor devices input as USB formatted packets constructed in a well-formatted message style. The input USB formatted packets may input message content from each sensor device in a well-defined format for translation and utilization in the user software application as well-formatted messages. The well-formatted messages provide for the initial setup and identification of sensor devices within the conduit software application and may allow a user to select parameters to identify the data input from the connected sensor device. The parameters a user may select may include data items such as the patient name, the data source, the date, or other parameters that are available to properly label the incoming data. Additional formatted messages may provide for the format and use of casing device parameters, message parameters, and ongoing data input from each sensor device. The conduit software application may also assign a label or other identifier to each input message so as to accumulate messages from the same sensor device and for the same patient in a temporary storage location reserved for that patient and each session of sensor data collection. The conduit software application may also establish a secure connection to a server software application and transmit all captured and labeled sensor data to a server computer system that is interconnected to a data network. The sensor data thus collected may be retrieved at a later time and reviewed through the use of the established label or other identifier for the stored sensor device input session.

In the exemplary embodiment, the server software application may host the data transmitted from the sensor devices by way of the conduit software application. The data collected and labeled by the conduit software application may be transmitted to the server and accumulated in an incoming message queue. The server may instantiate a server software application on the server computer, which may then store all transmitted data in a physical computer storage device for later retrieval and data operation using the label or other identifier associated with the captured sensor data. The stored transmitted data may be communicated to the at least one user by transferring the transmitted data to a personal computer, such as the conduit computer or another personal computer connected to the network, for display to a user. The server software application may perform operations upon the stored transmitted data to enable the display of the transmitted data that has been collected by devices such as a digital camera, a document scanner, USB configured medical sensor devices that detect EKG, SaO2, ETCO2, Temperature, Blood Pressure, EEG, or any other sensor device. The stored transmitted data including sensor measurement data, visual scan data, audio data, photographic data, multimedia formatted data or any other medical scan data may be displayed to the user through a user interface (UI) such as a web browser or other UI configured to display sensor device data formatted for user display.

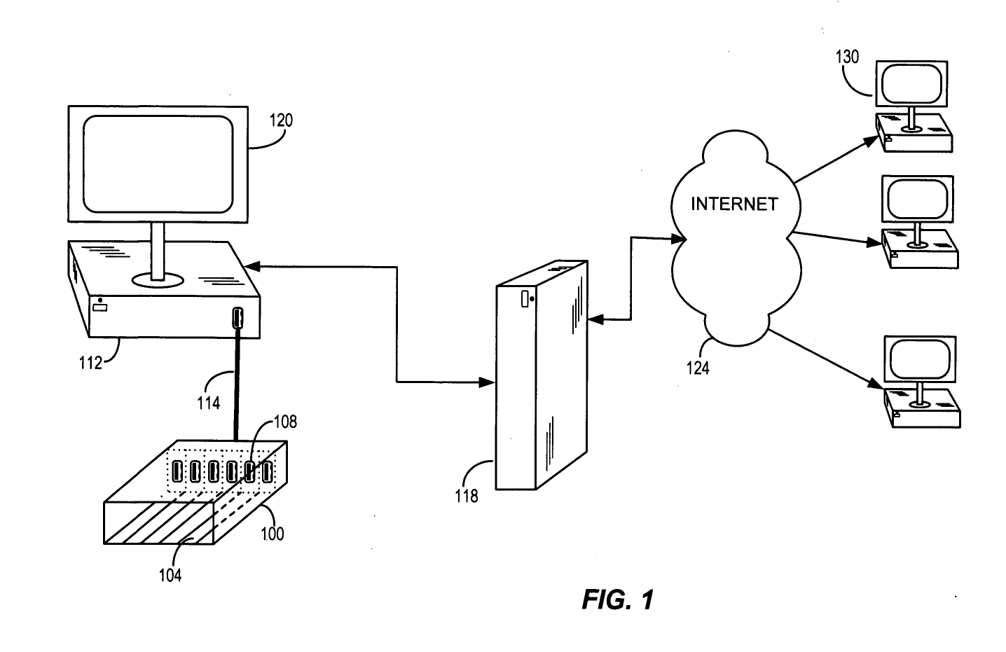

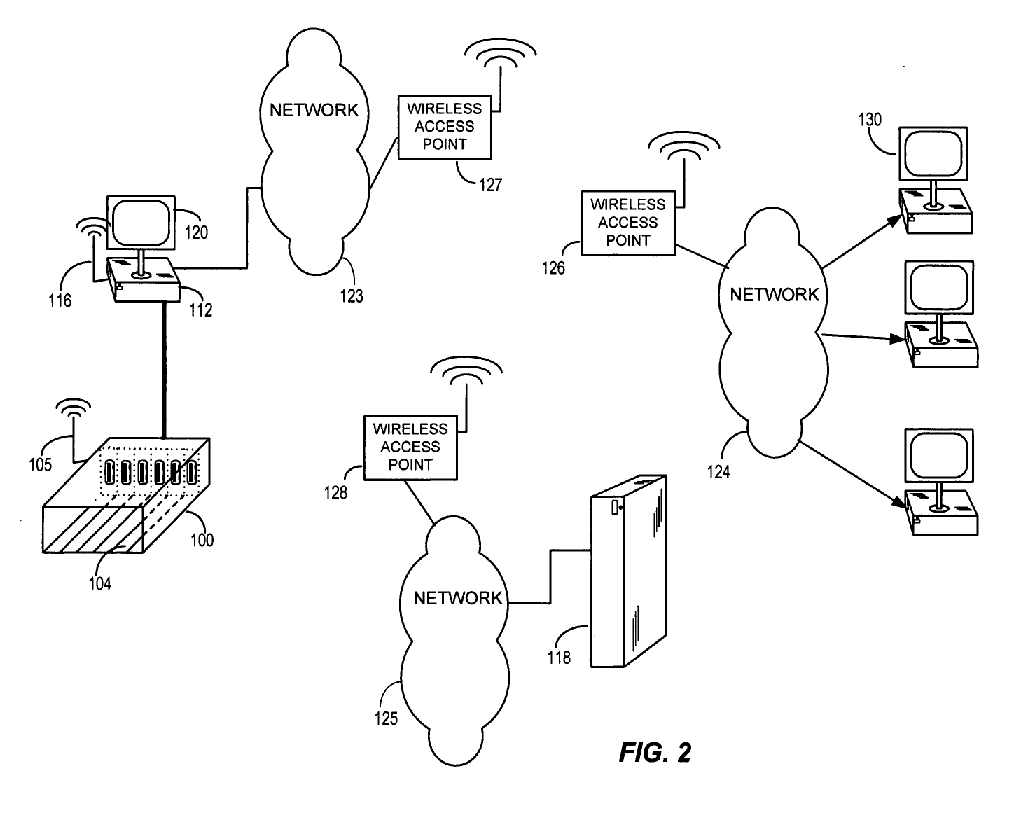

Turning now to FIG. 1, in an exemplary embodiment presents the implementation of the data stream manager in a non-limiting example of a wired communication interaction between the components of the system as a whole. The system implementation is not limited to just wired communication connections, however, as will be presented in the description of the system having general wireless connectivity in FIG. 2. A sensor device casing 100 has a configurable number of docking slots 104 into which sensor devices may be inserted. At the distal end of each docking slot 104 is embedded a USB connector 108 which may be configured as one port of a powered USB hub into which a USB output connector (not shown) is inserted to provide an electrical and data communication connection with the sensor device casing 100. The sensor device casing 100 shares the input electrical signal information from each docking slot by connecting all of the USB connectors from each docking slot to a single USB output port (not shown). In this exemplary configuration, a number of sensor devices such as USB configured medical sensor devices that 100 may be inserted into the sensor device casing 100 and begin the operation of collecting information. The collected data from each operational sensor device is transmitted to a conduit computer system 112 through a single wired connection from the shared USB port of the sensor device casing 100 to an input USB port 114 of the personal computer system 112. In the exemplary embodiment, each sensor device inserted within a sensor device casing transmits data using the same message style.

In an additional exemplary implementation, a sensor device may not be connected through the sensor device casing 100 and may, instead, be directly connected to the conduit computer system 112 through a direct USB port connector. Such a device may be connected to the conduit computer system 112 in cooperation with the sensor device casing 100 such that sensor devices that are connected to the sensor device casing 100 and sensor devices that are directly connected to the conduit computer system 112 are configured and operational simultaneously. A sensor device that is connected directly to the conduit computer system 112 may be provided with a default sensor device casing profile for identification and construction of data messages transmitted from the directly connected sensor device to a sensor data stream queue (not shown).

Upon receipt of the accumulated data from the sensor device casing 100 and any directly connected sensor devices, the conduit computer 112 may initiate a client software application to permit a user to select parameters to identify the incoming sensor data for each connected sensor device. The user may select a name, the date, the identifier of a sensor device, or any other parameter to assign to the data. Once the identifier for the data has been selected, the client software application will associate the identifier with the incoming sensor data by tagging the sensor data with a label or other appropriate identifier to identify the sensor device casing, sensor device, patient, and timestamp associated with the incoming sensor data and transmit the tagged data to a server computer system 118. The server computer system 118 may then capture the incoming tagged data in an incoming sensor data stream queue. The server software application may then, as a permanent storage function of the server software application, store the incoming tagged data into a physical computer storage device (not shown). The server software application may also prepare the incoming tagged data for display in a web-based format or other UI format configured to display sensor device data formatted for user display. The UI display formatted sensor device data may then be transmitted from the server computer to the conduit computer 112 for display on the display device 120 associated with the conduit computer 112. The server software application may also transmit the UI-formatted tagged data, or any tagged data retrieved from the storage device associated with the server computer 118 and formatted by the server software application for display on a user interface, to the network 124 for further current transmission to other computer systems 130 or for later retrieval and review to display the data to remotely located users.

In a further exemplary embodiment, additional sensor devices that are not configured for insertion into the sensor device casing 100 or for operations in which the sensor device casing 100 is not in use, but which have the capability to provide captured data through a USB port via USB cable may be separately connected to the conduit computer 112 and provide incoming sensor data for display and storage. The conduit computer 112 or other personal computer (not shown) may process the incoming data from the additional sensor device in the same manner and initiate the same client software application that performs data capture, labeling and display as the sensor device casing configuration where the directly connected sensor device will be assigned a default sensor device casing profile for purposes of data collection and message formatting from the directly connected sensor device.

Turning to FIG. 2, in another exemplary embodiment the communication of the sensor data from the sensor device casing 100 to the conduit PC computer system 112, from the conduit PC system 112 to the server computer 118, and from the server computer system to an access point 126 may be accomplished through wireless communication protocols such as Wi-Fi (IEEE 802.11x), Bluetooth, or other wireless protocols. In this exemplary embodiment data is captured by sensor devices installed in the sensor device casing docking slots 104 and the data accumulated by the installed sensor devices is transmitted from a wireless transceiver 105 incorporated within the sensor device casing 100. The incoming data from the sensor devices is tagged with the user parameter input by the user and transmitted from the conduit PC 112 via a wireless transceiver 116 associated with the conduit PC 112 using a wireless protocol as previously identified for the sensor device casing 100. Tagging of the data to be transmitted may include attaching a sensor device casing 100 profile identifier, a sensor device identifier, and may include patient data, such as, in a non-limiting example, patient and/or test measurement identification, entered into the conduit PC during the initialization of the measurement action. The patient and test measurement identification may be used as tracking identifiers either separately or in combination for all collected measurement data for each initialized sensor device. In this exemplary embodiment, the sensor device casing 100, once initialized, may wirelessly transmit measurement data to the network 123 through a wireless access point 127 without first transmitting the measurement data to the conduit PC 112. The transmitted tagged data is received by a server computer 118 through a direct, wired connection to a network 125. The tagged data may be received by a sensor data stream queue that is responsible for spooling the incoming streaming tagged data prior to storing the tagged measurement data in a physical storage device within the server computer 118. The tagged data received at the server computer 118 may then be formatted for a UI display and transmitted back to the wireless transceiver 116 associated with the conduit PC 112. The tagged data formatted for a UI display may also be transmitted from the server 118 across the network connection 125 to a wireless access point 127 connected to the local network 123. The UI display formatted data may then be transmitted to a second user PC 130 through another network connection 124, through a wireless access point 126 associated with another network connection 124, and through the network connection 124 associated with the separate user PC 130 where it may be displayed to additional users.

Turning now to FIG. 3, this figure presents a cutaway view of the internal configuration of the sensor device casing 100 in an exemplary embodiment where a number of sensor devices have been inserted into slots 104 in the sensor device casing 100 configured to accept such sensor devices. In this exemplary embodiment the sensor device casing 100 may also contain a powered routing hub 302. The USB interconnection may be through the powered USB hub 302 that collects USB formatted communication messages from a plurality of devices and transmits them to a personal computer through a single USB connection port. The USB hub 302 will provide all communication startup, handshake, and packet transfer actions for a sensor device casing that is directly connected to a conduit PC 112 through a wired connection. In an alternative embodiment, the sensor device casing 100 may transmit data through a wireless antenna incorporated within the sensor device casing 100. The sensor device measurement data may be transmitted through the use of Bluetooth, Wi-Fi (IEEE 802.11x), or other suitable wireless protocols. All sensor devices installed within a single sensor device casing 100 will transmit data using either a wired protocol or a wireless protocol.

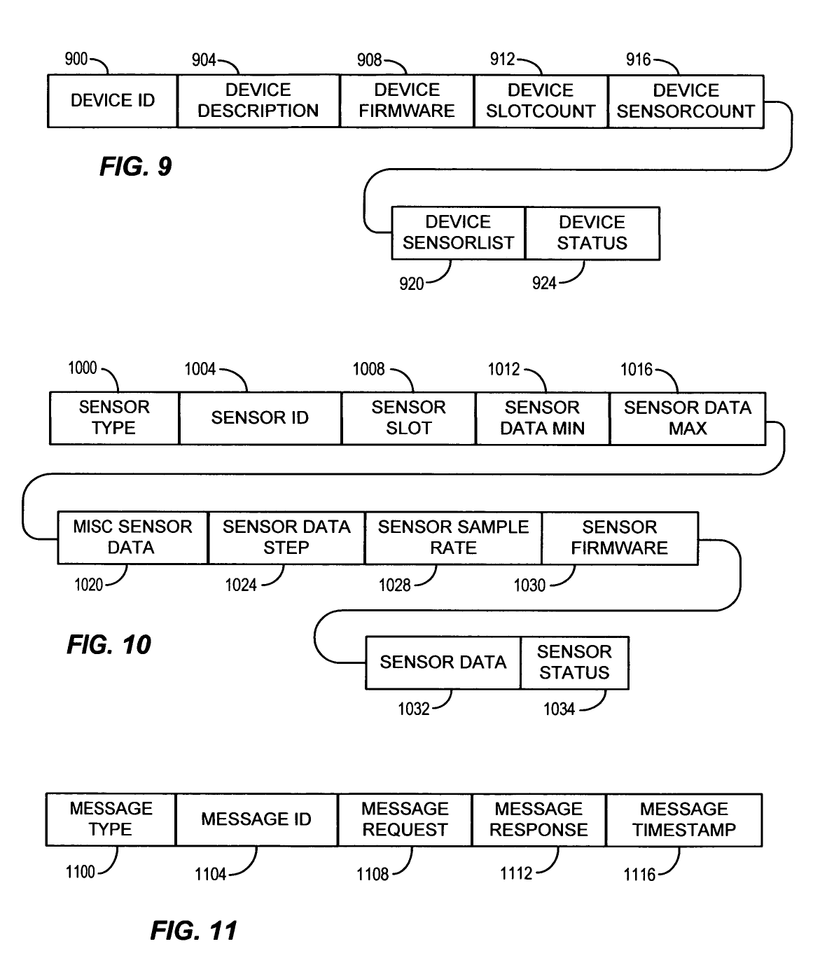

In an exemplary configuration, the single USB connection from the USB hub 302 to the conduit PC 112 will be shared by all devices and sensors connected to the USB hub 302 in the device sensor casing 100 using USB-style protocols. In a wireless configuration, the sensor devices may continue to connect to the USB hub 302, but data communication will be accomplished through wireless protocols. All sensor device measurement data may be transmitted through a messaging module having a message protocol for constructing and transmitting messages in a well-defined format as well-formatted messages. A transmitted message is a well-formatted message within the meaning of this disclosure when the message parameters include device parameters, casing device parameters, sensor parameters, and message parameters that are compatible with, and may be included in, USB protocol data packets. The parameters described for well-formatted messages are disclosed in FIGS. 9, 10 and 11 (see description below) and provide for the accumulation and transmission of sensor device data. The well-formatted messages may take advantage of the USB or wireless protocol to establish message setup and teardown when communicating from one device to another, and may insert message packets as data packets in the message format described later in this document. Messages composed as well-formatted messages may be transmitted to the conduit PC 112 as user defined data packets which may contain input data from any of a number of input devices. The powered USB hub 302 is configured such that a USB input port 308 is located at the distal end of each sensor casing device slot 104 to accept a USB connector for transferring from a sensor device 304 to the powered routing hub 302. When the sensor device 304 is fully inserted into the sensor casing device slot 104 the sensor device 304 is mechanically and electrically connected to the powered USB routing hub 302 such that data communication proceeds unimpeded from the sensor device 304 to the powered USB routing hub 302. In this exemplary embodiment, the powered USB routing hub 302 may collect all of the data communicated from each sensor device installed within the sensor device casing 100 and transmit the accumulated data over a wireless or wired connection to a conduit PC 112 for dissemination throughout the system and across the network 124.

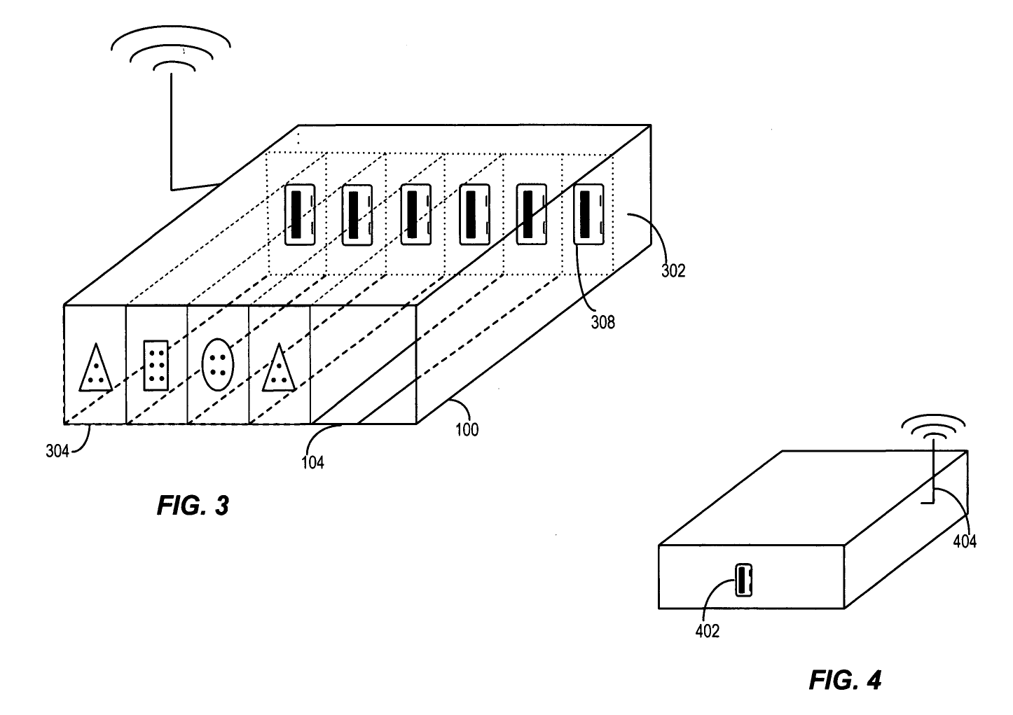

Turning now to FIG. 4, in an exemplary embodiment the sensor device casing 100 provides two methods for data communication from sensor devices 304 installed within the sensor device casing 100. In a wired connection system, the powered USB routing hub 302 may collect data communication from each of a plurality of sensor devices installed within the sensor device casing 100. The data collected may be collated and transmitted from the sensor device casing 100 to an exterior computer system though a USB connector 402 on the back surface of the sensor device casing 100. In an alternative embodiment, the data collected may be collated and transmitted from the sensor device casing 100 to an exterior computer system through the use of a wireless transceiver 404.

A data collection module may be operative to collect and sort the data from either the wired or wireless source for data formatting and presentation to a user of the system. Additionally, the computer system data collection module may be operative to collect sensor device data from sensor devices that are connected directly via a wired connection to the computer system, or wirelessly from a sensor device that includes a wireless transceiver within the stand alone device. In this exemplary embodiment, the system may be configured to collect, manipulate and display sensor device data from sensor devices installed within the sensor device casing 100, either wirelessly or through a wired connection, or in conjunction with additional sensor devices that are not installed in the sensor device casing 100.

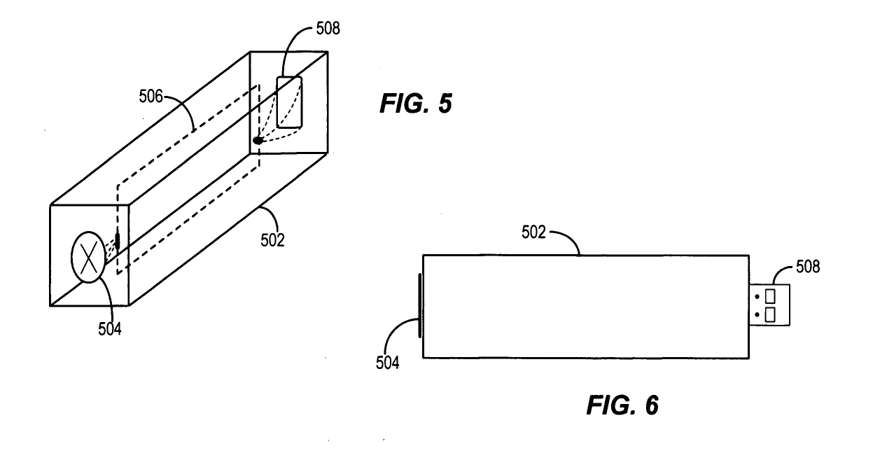

Turning now to FIG. 5, this figure presents an exemplary configuration for a sensor device 502 adapted to be installed within an unoccupied slot of a sensor device casing (see FIG. 1). The sensor device 502 in this exemplary configuration may have a front surface mounted connector specific to a particular sensor device or the connector may be a Universal connector 504 integral to the sensor device to introduce input measurement device readings from the measurement source into the sensor device 502. The connector 504 may be specific to the sensor device from which measurement data is to be collected. In an alternative embodiment, the connector 504 may be a unique interface represented by a Universal connector. The Universal connector integral to the sensor device may have one or more leads, such as electrically conductive wires or other types of data collection and transmission media, that attach to a patient and join into a common element that forms a single input measurement collection interface 504 of the sensor device 502. The Universal connector 504 may be operative to pass incoming data input from the input measurement device to the sensor device collection component 506 of the sensor device 502.

The sensor device collection component 502 may be any type of medical sensor device including, but not limited to sensor devices such as USB configured medical sensor devices that detect EKG, SaO2, ETCO2, Temperature, Blood Pressure, EEG, or any other sensor device, that may be configured for installation and operation within the form factor of the sensor device 502. The sensor device controller 506 may then transmit the formatted measurement data to the computer system through a USB connector 508 installed within the back face of the sensor device 502, or the formatted measurement data may be transmitted wirelessly through a wireless transceiver configured as an integral component within the sensor device 502.

In association with FIG. 5, the sensor device 502 shown in FIG. 6 presents a side view of the sensor device 502 displaying the front surface connector 504 and a side view of the USB connector 508 mounted into the back face of the sensor device 502. When the sensor device 502 is fully inserted into the sensor device casing 100 the USB connector 508 will be mechanically and electrically connected into the USB connector at the distal end of a sensor casing slot. In an exemplary embodiment, a client application module operative within the personal computer associated with the system may then recognize the sensor device 502 and upload data from the sensor device 502 in accordance with the specificity of the medical device and the vital sign data being collected by the sensor device 502.

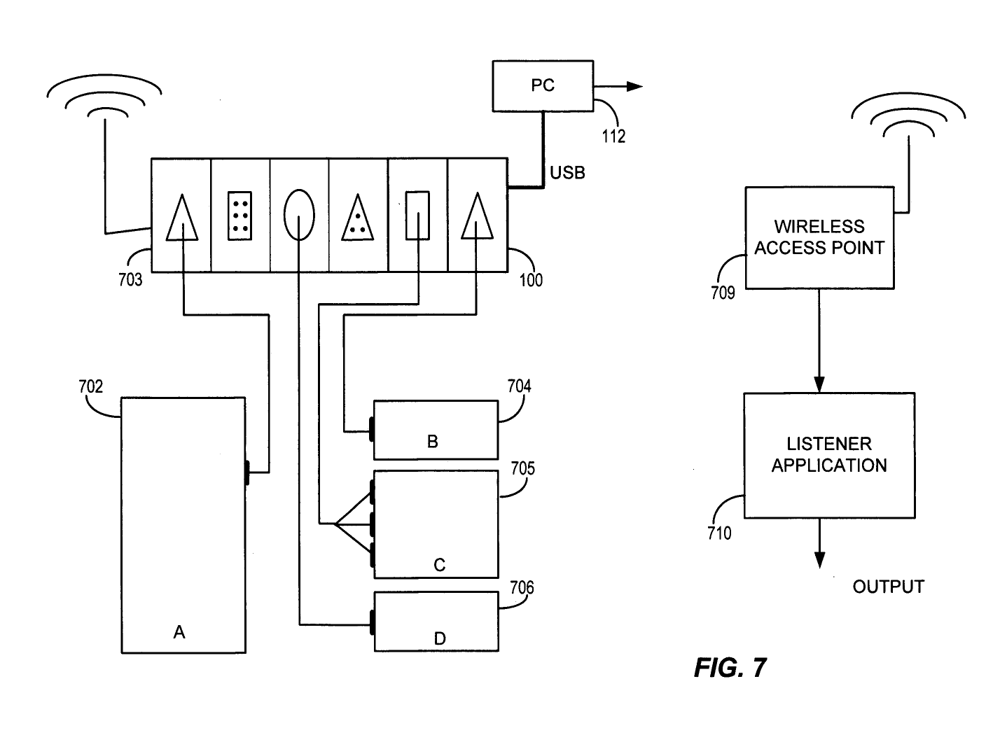

Turning now to FIG. 7, this figure presents a fully implemented system configuration with a first medical sensor attached to a first measurement source A 702 and attached to a sensor device inserted within a sensor device casing 100. The measurement source A 702 may, in an exemplary implementation, be either a sensor device or may represent a direct attachment of a sensor device input connector to a patient. In a non-limiting example, if the measurement source A 702 is a connection to a patient, the connection may be a blood pressure measurement device that may be attached to the patient and the blood pressure measurement may be directly input to the sensor device 703 installed within the sensor device casing 100. Upon activation, the blood pressure measurement signals are transmitted from the patient 702 directly through the sensor device 703 where they are captured by the conduit PC system 112.

In this exemplary embodiment a plurality of medical sensors are attached to a second measurement source B 704, a third measurement source C 705, and a fourth measurement source D 706. Each of the measurement sources, which may each be a different sensor device or a direct attachment of a sensor device input connector to a patient, is attached to a plurality of sensor devices inserted within separate channels in the same sensor device casing 100. In an additional embodiment, any of the measurement sources may be connected directly either through a wired or wireless connection directly (not shown) to the conduit PC system 112. As described above, the data is collected from each measurement source through the sensor devices installed within the sensor device casing 100 or directly connected sensor devices (not shown). The measurement data is then transmitted from the sensor device casing 100 to the conduit PC system 112 for identification processing. The conduit PC system 112 establishes a secure connection to a server and streams the measurement data to a listener software application 710 instantiated on the server to detect sensor data incoming to a data collection queue from any sensor device for storage and formatting. In an alternative embodiment, the conduit PC 112 may be utilized for setup and initialization of all sensor device casings, sensor devices, and measurement data message transfer and, upon completion of these tasks, may be circumvented by the sensor device casing 100 for streaming measurement data to the server 118. This exemplary embodiment is operational only when the data communication occurs through wireless transmission of the measurement data, at which time the sensor device casing 100 may continue to stream sensor device measurement data through a wireless connection directly from the sensor device casing 100 to the network 709.

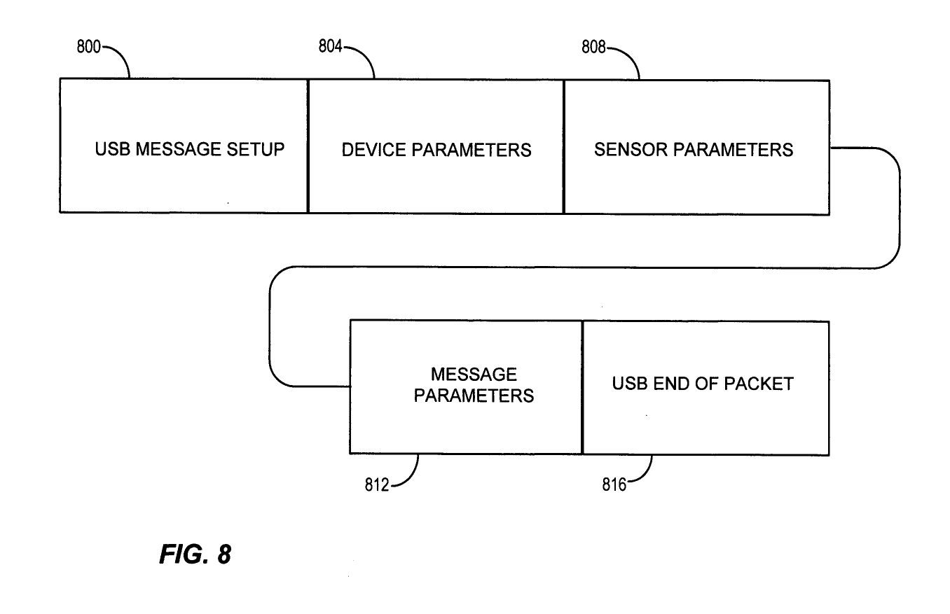

Turning now to FIG. 8, an exemplary implementation for the messages communicated as well-formatted messages between sensor devices and a computer system is presented. Well-formatted messages are constructed using the format and configuration of standard USB messaging to initiate communication and to manage the communication stream from one device to a second device. The well-formatted message input stream consists of USB data packets constructed in the format described below and transmit sensor device data collected from the sensor device to the computer system during operation of the sensor device. The data may be streamed in at least two separate styles based upon the type of sensor device and the type of data to be collected and streamed to the computer system.

In an exemplary implementation, a first style for data collection builds a message for sensor devices that collect sensor data with no lag time between the connection of the sensor device and the transmission of collected sensor data to the computer system. This style of message may be referred to as an instant style of messaging. In an instant style message, after the message setup 800 to enable USB data communication is complete, the sensor device may transmit one or more packets as well-formatted data packets that contain device parameters 804 for the particular sensor device. The device parameters 804 may contain a number of fields that provide the information for the computer system to identify the sensor device from which data is being communicated. The device parameters 804 will be described further in association with FIG. 9.

Sensor device parameters 808 may be communicated after the device parameters have been communicated. Sensor device parameters 808 are those parameters that provide description, identifier, and data value information for an indicated sensor device type. The sensor device parameter 808 packets are constructed of particular sensor device fields and may be transmitted immediately after the USB message protocol has completed and may be sent for each discrete measurement captured by the sensor device and transmitted to the computer system in a continuous stream for the instant message style.

Message parameters 812 may be communicated to facilitate the communication between the sensor device capturing the data and the computer system. Message parameters 812 may consist of message type and identifiers and may include a timestamp associated with each transmitted message. The timestamp not only provides a time associated with the data capture included in the message, but also may be used to synchronize multiple data streams when messages from more than one sensor device are being transmitted through the shared USB port.

The instant style message may terminate with standard USB end of packet and end of message protocol 816 to end the data transmission for a particular instant style message. In a non-limiting example, a sensor device that might make use of the instant style of message would be an EKG (electro-cardiogram) device. The EKG device would begin collecting and transmitting sensor measurements as soon as the USB communication message setup 800 is complete with no further lag time, and may continue to collect measurements at discrete intervals and transmit this sensor data to the computer system as long as the device is operative and enabled for data collection. Other sensor devices may also make use of the instant style message for streaming data from the sensor device to the computer system.

In an exemplary implementation, a second style of well-formatted message may be transmitted from a sensor device to the computer system. This second style of well-formatted message is termed a packet message style and may be used by those sensor devices that require a buildup of biometric parameter data before collection of relevant sensor measurement data may begin. A non-limiting example for a device that may make use of the packet message style might be a blood pressure sensor device. The blood pressure sensor device may be initiated and the USB messaging transmitted in accordance with the message structure described above, however, there will be a lag in time between the initiation of the blood pressure sensor device and when the first sensor parameter packets 808 that contain meaningful measurement data are available for transmission. Just as in the instant style message previously described, the packet style message may consist of device parameters 804, sensor parameters 808, and message parameters 812. The packet style message may also continue to stream data collected from the sensor device after the initial lag time. Other sensor devices may also make use of the packet style message for streaming data from the sensor device to the computer system.

Turning now to FIG. 9, this figure presents a message format diagram for device parameters to be communicated from a sensor device to a designated computer system for all well-formatted message styles. The sensor device casing and sensor devices have both device-specific and user-defined settings that may require setup and configuration each time the sensor device casing or sensor device is connected to the system. The device-specific settings are stored on the device in non-volatile memory. The user-specific settings may be stored in volatile memory in the sensor device or within an alternative storage device connected to the sensor device or a sensor device casing.

The fields presented in the message format diagram are defined to provide information about both sensor device casing and non-sensor device casing connected devices. The initial field, labeled Device ID 900 provides an identifier for the particular device for which the associated packet is presenting collected data. The device identifier may be any alphanumeric string that uniquely identifies the sensor device to the system. In addition, the device identifier may be used in association with a patient identifier and a timestamp to create a unique storage identifier for use in storing and tracking sensor device measurements for a given sensor device, measurement session, and patient. The next field in the device parameters is labeled Device Description 904, and may be used to display information about the device to a user of the system to make identification of the device easier for the user. The next field is labeled Device Firmware 908, and provides an identifier for the firmware version installed in the particular device currently connected. If a sensor device is connected directly to a conduit computer and is not installed within a sensor device casing, the Device Firmware 908 field is not applicable. The next field is labeled Device SlotCount 912, and provides an indicator for the number of devices that may be connected to the system at one time. The next field is labeled Device SensorCount 916, and provides the number of sensor devices currently connected to the system. The Device SensorCount 916 may include sensor devices connected through a sensor device casing or sensor devices connected directly to the designated computer system (per casing device). The next field is labeled Device SensorList 920, and provides a list of all Sensor IDs for the set of all sensor devices currently connected to the designated computer system. The final field in the Device parameter packet is labeled Device Status 924, and provides a status list presenting the device status for each device currently connected to the designated computer system. Device Status values may include Idle, Active, and Error, as well as any other status that may be defined for reporting such status to the designated computer system client application.

Turning now to FIG. 10, this figure presents a message format diagram for sensor parameters to be communicated from a sensor device to a designated computer system for all well-formatted message styles. The fields presented are defined to provide information about both sensor casing and non-sensor casing devices. The initial field, labeled Sensor Type 1000 provides information about the type of sensor device from which the sensor data is being collected and transmitted. The next field, labeled Sensor ID 1004 provides a globally unique ID for the sensor device transmitting collected sensor data. The following field, labeled Sensor Slot 1008 provides an identifier for the slot within a sensor device casing in which the sensor device is connected. If the sensor device is directly connected to the conduit computer system 112 this value may be set to 0 for the first sensor device to be directly connected to the conduit computer system. For all subsequent sensor devices that may be directly connected to the conduit computer system while other sensor devices remain directly connected, the Sensor Slot 1008 value for subsequent directly connected sensor device may be auto incremented based upon the priority for the directly connected sensor device. In a non-limiting example, if three sensor devices are to be configured and they are each directly connected to a conduit computer system the Sensor Slot 1008 value for the first sensor device to be directly connected may have a value of 0, the second directly connected sensor device may have a Sensor Slot 1008 value of 1, and the third directly connected sensor device may have a value of 2. The Sensor Slot 1008 value may be auto-incremented in any fashion necessary The next field, labeled Sensor DataMin 1012, provides the value for the minimum acceptable data value for a sensor of this type. In a typical sensor device this value may be set to 0, but it may be set to a value other than zero during configuration activities when setting up the sensor device for communication with the system. The next field, labeled Sensor DataMax 1016 provides the value for the maximum acceptable data value for a sensor of this type. In a typical sensor device this value may be set to 255, but it may be set to a value other than 255 during configuration activities when setting up the sensor device for communication with the system. The next field, labeled Misc Sensor Data 1020 provides a data field that is reserved for future use.

The next field, labeled Sensor Data Step 1024 provides the value for the step size of the data values. The step size represents the incremental value of the step from one measurement to the subsequent measurement. This value may be positive or negative and may be set to any value consistent with the sensor device configured. This value may have a default value set by the device manufacturer. The next field, Sensor Sample Rate 1028, provides the data sample rate for the particular sensor device. This sensor sample rate may be expressed as a time interval (1 minute, 1 second, etc.) or it may be expressed as continuous, which may provide for sampling to occur at the minimum sample interval rate at which the sensor device is capable of operation. This parameter is configurable by the device manufacturer

The next field, Sensor Firmware 1030, provides the firmware version of the sensor device and may be automatically collected from the sensor device when it is connected to the sensor device casing or designated computer system. With all sensor parameters configured for the connected sensor device, the Sensor Data field 1032 contains the measured data value for each cycle of the measurement action. In a non-limiting example, using the Sensor SampleRate 1028, the system collects a measurement from the sensor device at each interval specified by the Sensor SampleRate 1028 and places this data value in the Sensor Data field 1032 for transmission to the server. The final field of the sensor parameters is labeled Sensor Status 1034, and provides a sensor status for each sensor device currently connected to the designated computer system. Sensor Status values may include Idle, Active, and Error, as well as any other status that may be defined for reporting such status to the designated computer system client application.

Turning now to FIG. 11, this figure presents a message format diagram for message parameters to be communicated to a designated computer system for all well-formatted message styles. The fields presented are defined to provide information about both sensor casing and non-sensor casing devices. The initial field, labeled Message Type 1100, provides a designation of the type of message being transmitted. Message types may include such messages as configuration, input, output, and error message types, as well as additional message types that may be specific to a particular sensor device type, or may be defined in the future. The next field, labeled Message ID 1104, provides the unique identifier for the message being communicated. The next field, labeled Message Request 1108 may consist of any initialization field that the conduit software application recognizes as a request to begin streaming a well-formatted message. The next field, labeled Message Response 1112, may consist of any response field value, such as in a non-limiting example an ACK or a NAK response, that the conduit software application may recognize as an acknowledgement of the transmission of a well-formatted message of any type. The final field is labeled Message TimeStamp 1116, and provides the data and time that the message was sent.

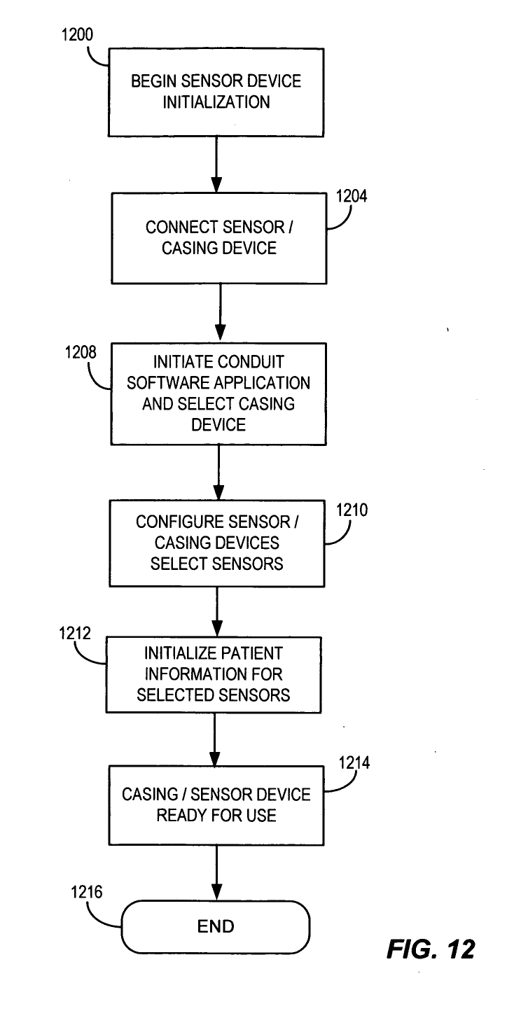

Turning now to FIG. 12, in an exemplary embodiment at 1200 the data stream manager system is initiated for use by initializing a sensor device for operation with the system. The data stream manager system is configured by inserting one or more sensor devices into the sensor casing, or directly connecting one or more sensor devices to a conduit computer system at 1204. At 1208, the conduit software application may be initiated within the designated conduit computer system, which may, in a non-limiting example, be a personal computer system. The conduit software application, once initialized, may select a sensor device inserted within a sensor device casing, or may select a sensor device that has a direct connection with the conduit computer system. In the example of a sensor device connected directly to the conduit computer system, a default profile setting may be provided for sensor device casing parameter settings, indicating that the sensor device thus connected is not inserted within a sensor device casing. At 1210, the conduit software application instantiated within the conduit computer system may configure sensor devices, sensor casing devices, and select one or more sensors from which to collect and stream sensor device measurement data. The sensor device data may be streamed from the sensor devices selected in any style as previously described.

At 1212, the conduit software application may present a UI display request to associate a patient identifier to be associated with the incoming sensor device measurement data. A user or staff member may select the name of a patient from a list of patient names, or the user or staff member may be prompted to input the name of a patient with which to associate the incoming sensor device data measurements.

In the exemplary embodiment once the data measurements are associated with an individual patient the system is operational and ready to collect vital sign and other data measurements at 1214. The conduit software application enters a wait mode and ends the initialization process at 1216.

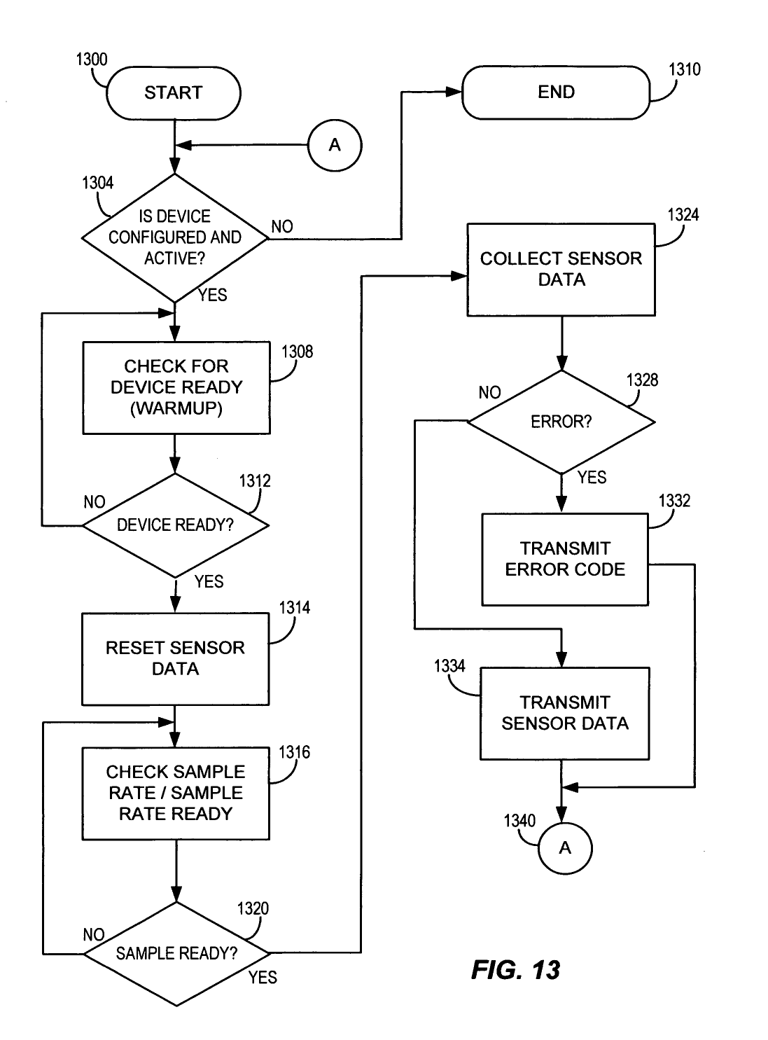

Turning now to FIG. 13, this figure presents an exemplary embodiment for the initialization and data measurement collection of any individual sensor device. In the exemplary embodiment, the client software application instantiated within a conduit or other computer system is ready to begin accepting and streaming sensor device measurement data at 1300 by initiating a data collection operation. The sensor device checks at 1304 to determine if the sensor device is fully configured to collect sensor device measurement data, and is currently in an active data measurement collection state. If the sensor device is not configured or is not actively awaiting operation, the sensor device terminates the data collection operation for that sensor and returns to a wait state at 1310.

In the exemplary embodiment, if the sensor device is connected, configured and actively ready to collect sensor device measurement data, an internal logical status query may be performed at 1308 to query the status of the sensor device. A sensor device may require time to accumulate the biometric data that it will measure and report, or the sensor device may require time to progress through sensor device startup operations to achieve a ready to operate status. During this time frame, the sensor device may not be ready to operate and may return a simple response to the internal logical status query. The sensor device checks the response to the status query at 1312 to determine whether the sensor device has completed startup and initialization actions and is ready to begin data collection. If ready, the sensor device issues a reset sensor data message to set the sensor data collection fields to a pre-set default value. The default value is pre-set during the sensor device initialization process, described earlier. Setting the sensor data field to a default value clears the sensor data field to a known neutral value and clears the previous recorded measurement data value from the sensor data field, preparing the sensor data field to capture the next sensor device data measurement.

The sensor device enters the check sample/sensor sample rate state during the operation of the sensor device at 1316. The check sample state provides an operational state for the sensor device for the collection of the sensor device measurement data. The sensor sample rate is pre-set by a sensor device manufacturer and input to the sensor device parameters during the initialization of the sensor device parameters, described above, and provides the timeframe for the collection of sensor device measurement data. An apparent sensor sample rate may be formed during the operation of the sensor device for a particular measurement session by the selection and retention of fewer samples than the sensor device may collect at the pre-set sample rate. An apparent sample rate may be established at 1316 to reflect the user desired sensor sample rate for a particular data measurement collection session.

The sensor device checks at 1320 to determine if the sample time has elapsed and whether the sample measurement is ready to be collected. In a non-limiting example the biometric data may take some time to accumulate to a point at which a measurement becomes meaningful, or, in an alternative example, the accumulation may be nearly instantaneous. If the sample measurement is not yet ready, the sensor device returns to the wait state at 1316 and performs another check for a sample measurement ready to be collected at the end of the next sensor sample rate time interval. If the sample measurement check reports that the sample measurement is ready to be collected, the sensor device at 1324 collects the measurement data from the sensor device input connector. At 1328 the sensor device may check for any error in the collection of the sensor device measurement data. In the exemplary embodiment, an error may be the result of unknown or corrupt data from the sensor device, or may be caused by the termination of communication with the sensor device. If the sensor device discovers an error in the data or data communication at 1328, the sensor device may transmit an error code at 1332 to inform the user of the system that an error of some type has been detected. In a non-limiting example, an internal list of errors that may occur, such as connection errors or data errors, among other error types, may be maintained and an error code may be pulled from the list and transmitted. In this example, errors may be defined for simple data errors indicating that a single measurement is faulty, catastrophic errors that indicate a corrupted measurement action, sensor device unknown status errors, or any other error that may need to be communicated to a user of the system. After the insertion of such an error code in a message to be transmitted to the user, the sensor device may terminate the current data collection operation for the sensor device at 1340 and return to the sensor device initialization process at 1304 to restart the data measurement operation.

At 1334, if there is no error, the sensor device measurement data collected from the sensor device is transmitted to a volatile memory structure, such as a spooling queue for data collection, established within a server computer system. At the termination of the transmission of the sensor device measurement data from data collection operation, the system may return to the device configuration check point at 1304 to begin another data collection operation. If the sensor device is no longer configured and active as determined by a sensor device check at 1304, the sensor device may terminate data collection operation at 1310.

In an additional exemplary embodiment, the sensor device may enter a diagnostic or demonstration mode at 1300. The diagnostic or demonstration mode may perform substantially the same operations as described above with respect to data measurement collection by the sensor device.

In the exemplary embodiment, the diagnostic or demonstration mode of the sensor device may provide a user with additional configuration options for sensor device settings at 1304. The additional configuration options may provide a user with the ability to set parameters that are outside of the normal range of the sensor device, or may provide additional meanings for device or sensor fields in a message packet for the discovery of maintenance or error conditions with the sensor device, or reporting demonstration data. In addition, at 1334 these data parameters may be configured to communicate with any computer established as a destination device for the demonstration or diagnostic sensor data, such as, in a non-limiting example, returning all data values to the conduit computer system for immediate display.

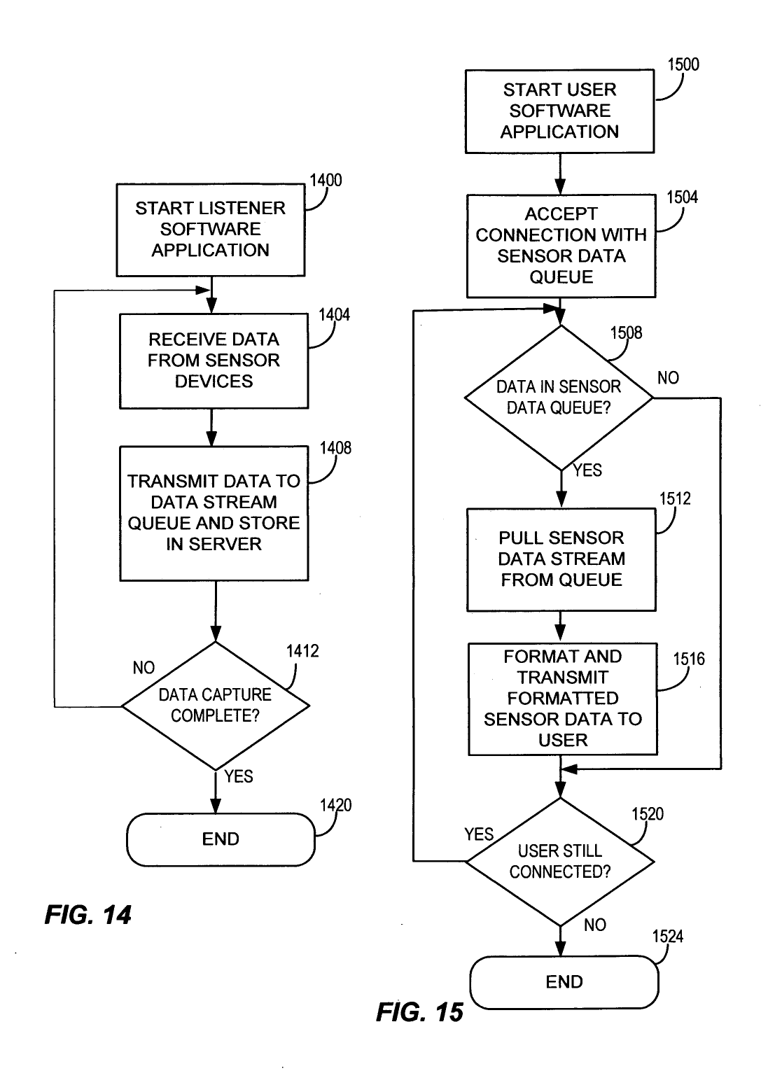

Turning now to FIG. 14, this figure presents an exemplary implementation of the operation of the listener software application. At 1400, the listener software application is instantiated within the server computer system, which may be any PC configured with the listener software application. At 1404, the listener software application will receive data from one or more sensor devices that have been previously initialized and configured for data collection. At 1408, during operation, the sensor device measurement data may be streamed to a server to be stored into a temporary, volatile memory structure such as, in a non-limiting example, a spooling or circular queue that may operate as a continuous data streaming queue instantiated within a server in communication with the conduit computer system or sensor casing device. The sensor device measurement data may be collected from one or more sensor devices in one or more data streaming styles, as previously described, and, at 1412, the listener software application checks to determine if the data measurement capture operation has terminated for any reason. If the data measurement capture operation has not been terminated, the listener software application returns to the data capture and receive function at 1404. If the data measurement capture operation has terminated, the listener software application terminates operation at 1420.

Turning now to FIG. 15, this figure presents an exemplary implementation of the operation of the server software application. At 1500, the server software application is instantiated on a server computer system. At 1504, the server software application receives a request for communication with a user computer system. The server software also establishes a communication connection at 1504 with a sensor data stream queue maintained on the server. The input data stream queue may accept incoming sensor data and may spool this data within the queue until the server software application pulls the data from the input data stream queue. The measurement data from multiple sensor devices may be aggregated within the input data stream queue for capture and processing by the server software application. The server software application may, in this exemplary implementation, perform a check at 1508 to determine if there is data that has been received at the data stream queue maintained within the server computer system. At 1520, the server system checks to determine if the user computer system is still connected and in data communication with the server computer system.

If at 1508, data has already been received into the data stream queue, the server software application pulls the data from the data stream queue at 1512. The server software application formats the received data stream queue information at 1516 in a format consistent for display on the UI display associated with any user computer system. The formatted data is stored in permanent storage on the server computer system and, also at 1516, transmits the formatted measurement data to a client computer system across the established communication channel between the client computer system and the server computer system. At 1520, the server software application performs a check to determine if the client computer system is still connected and in data communication with the server computer system. If the data receive operation is incomplete, or there is more information to be processed by the server computer system, the process returns to 1508 to continue to receive and process data from the data stream queue transmitted from the data source. If at 1520, the server software application performs a client connection check and the communication with the client software application or sensor data source is no longer active, the server software application may terminate the operation at 1524.

While certain illustrative embodiments have been described, it is evident that many alternatives, modifications, permutations and variations will become apparent to those skilled in the art in light of the foregoing description.

What is claimed is:

1. An apparatus for collecting medical sensor data comprising:
a multiple input sensor device casing comprising multiple input adaptors for connecting a plurality of medical sensor and monitoring devices and collecting incoming sensor and monitoring data from the plurality of medical sensor and monitoring devices;
the multiple input sensor device casing having a routing hub comprising a network connection and a plurality of software modules operative to format incoming sensor and monitoring device data into a communication stream of medical sensor data;
a network communication channel operative to transmit the stream of medical sensor data through the network communication channel;
the multiple input sensor device casing aggregating medical sensor device measurement data from all medical sensor and monitoring devices and transmitting the aggregated medical sensor device measurement data through the network communication channel to one or more server computers.

2. The apparatus of claim 1, where the sensor device casing provides a plurality of sensor device casing slots.

3. The apparatus of claim 2, where each of the sensor device casing slots is configured to accept one of a plurality of medical sensor devices.

4. The apparatus of claim 1, where the sensor device casing having one or more sensor devices installed within sensor device casing slots communicates collected sensor device measurement data to a data stream input queue on a server computer system.

5. The apparatus of claim 4, where the data stream input queue may accept input sensor device measurement data from sensor devices installed within a sensor device casing and sensor devices independently connected to the server computer system.

6. The apparatus of claim 1, further comprising one or more sensor devices that detect and collect measurement data for EKG, SaO2, ETCO2, Temperature, Blood Pressure, or EEG medical tests, or any other sensor device configured for use with the sensor device casing.

7. The apparatus of claim 1, where the network communication channel for data transmission of collected sensor device measurement data is a wireless or wired connection to a network.

8. A method for collecting medical sensor device measurement data comprising:
connecting one or more medical sensor devices to a sensor device casing or conduit computer system;
initializing the one or more medical sensor devices to an initial operation state in preparation for collecting biometric data;
configuring the one or more medical sensor devices with pre-determined data measurement and communication parameters;
establishing a network communication channel for transmitting collected sensor device data;
aggregating the collected sensor device data for all initialized sensor devices and communicating the collected sensor device data to an input data stream queue on a network server computer system through the network communication channel;
reading the transmitted sensor device data from the input data stream queue and storing all transmitted sensor device data into at least one storage device in the network server computer system.

9. The method of claim 8, where the one or more sensor devices are connected to a sensor device casing and a conduit computer system and transmitting measurement data to a single data stream input queue.

10. The method of claim 8, where initializing the one or more medical sensor devices is performed by a user operating a designated computer system connected to the one or more medical sensor devices.

11. The method of claim 8, where configuring the one or more medical sensor devices comprises assigning a unique tracking identifier to data collected by each of the one or more medical sensor devices.

12. The method of claim 9, where the assigned unique tracking identifier comprises at least a patient identifier, sensor device identifier, and sensor device casing identifier.

13. The method of claim 8, where the network communication channel is either a wireless channel or a wired channel to the network.

14. The method of claim 8, where each medical sensor device is connected to a measurement source through a single adaptor having input connectors individually configurable for each type of medical sensor device.

15. The method of claim 8, further comprising formatting the collected sensor device measurement data into a format for display on a user interface display for presentation to one or more users through a network data communication connection.

16. A computer readable medium embodied in a computer storage device for collecting medical sensor device measurement data comprising:
connecting one or more medical sensor devices to a sensor device casing or conduit computer system;
initializing the one or more medical sensor devices to an initial operation state in preparation for collecting biometric data;
configuring the one or more medical sensor devices with pre-determined data measurement and communication parameters and assigning a tracking identifier for data collected by each of the one or more medical sensor devices;
establishing a network communication channel for transmitting collected sensor device data;
aggregating the collected sensor device data for all initialized sensor devices and communicating the collected sensor device data to an input data stream queue on a network server computer system through the network communication channel;
reading the transmitted sensor device data from the input data stream queue and storing all transmitted sensor device data into at least one storage device in the network server computer system.

17. The computer readable medium of claim 16, where the one or more sensor devices are connected to a sensor device casing and a conduit computer system and transmitting measurement data to a single data stream input queue.

18. The computer readable medium of claim 16, where initializing the one or more medical sensor devices is performed by a user operating a designated computer system connected to the one or more medical sensor devices.

19. The computer readable medium of claim 16, where the assigned unique tracking identifier comprises at least a patient identifier, sensor device identifier, and sensor device casing identifier.

20. The computer readable medium of claim 16, where each medical sensor device is connected to a measurement source through a single adaptor having input connectors individually configurable for each type of medical sensor device.
